(19) United States
(12) Patent Application Publication
(10) Pub. No.: US 2009/0235858 A1
(43) Pub. Date: Sep. 24, 2009

(54) Bell having one-way clapper

(76) Inventor: Jui-Jen YUAN, Taichung (TW)

Correspondence Address: CHARLES E. BAXLEY, ESQUIRE, 90 JOHN STREET, SUITE 309, NEW YORK, NY, 10038, US

(21) Appl. No.: 12/077,276

(22) Filed: Mar. 18, 2008

(51) Int. Cl. G10K 1/071

(52) U.S. Cl. 116/171

(57) ABSTRACT

A bell includes a securing device for securing a bell member and a handle together, and a clapper device having an axle rotatably attached to the securing device for allowing the clapper device to be rotated relative to the securing device and to selectively strike onto the bell member in one direction, and a stop formed on the clapper device for engaging with the securing device and for limiting a rotational movement of the clapper device relative to the bell member and the securing device, and for preventing the clapper device from striking onto the bell member in an opposite direction and thus for allowing the sound generated by the clapper member and the bell member to be clearly heard by the users.

### BACKGROUND OF THE INVENTION

1. Field of the Invention

The present invention relates to a bell, and more particularly to a bell including a one-way clapper member for striking the bell member in only one direction and for preventing the one-way clapper member from striking the bell member in the other or the opposite direction.

2. Description of the Prior Art

Typical bells comprise a bell body, and a jinglet, sounder, hammer, tongue, striker or clapper disposed in the bell body and movable to strike against the bell body, in order to make various sounds. Normally, the bell body is required to be moved, shaken, vibrated or oscillated or operated by the users in order to make the sounds, and the striker or clapper may be moved in both directions or in all directions to strike onto the bell body and to make the sounds.

The closest prior art of which the applicant is aware is his prior U.S. Pat. No. 6,739,282 to Yuan which discloses one of the typical bells comprising an actuator rod for being operatable to actuate onto the striker or clapper and for forcing the striker or clapper to strike onto or against the bell body and so as to make various sounds without shaking or oscillating the bell body by the users.

However, similarly, the striker or clapper may also be moved in both directions or in all directions to strike onto the bell body and to make the sounds, and the striker or clapper may be forced to strike onto the bell body two or more times when the typical bell is moved or shook once by the users, such that the user may not clearly hear the scale and/or the tone of the sounds.

The present invention has arisen to mitigate and/or obviate the afore-described disadvantages of the conventional bell assemblies or devices.

### SUMMARY OF THE INVENTION

The primary objective of the present invention is to provide a bell including a one-way clapper member for striking the bell member in only one direction and for preventing the one-way clapper member from striking the bell member in the other or the opposite direction and thus for allowing the sound generated by the one-way clapper member and the bell member may be clearly heard by the users.

In accordance with one aspect of the invention, there is provided a bell comprising a handle, a bell member, a securing device securing the bell member and the handle together, and a clapper device including an axle provided on a first end portion and rotatably attached to the securing device for allowing the clapper device to be rotated relative to the securing device and to selectively strike onto the bell member in one direction, and including a stop provided on the first end portion of the clapper device for engaging with the securing device and for limiting a rotational movement of the clapper device relative to the bell member and the securing device, and for preventing the clapper device from striking onto the bell member in an opposite direction and thus for allowing the sound generated by the one-way clapper member and the bell member may be clearly heard by the users.

The bell member includes an aperture formed therein, and the securing device includes a panel and a shank extended from the panel and engaged through the aperture of the bell member to secure the securing device to the bell member with such as the force-fitted engagement.

The securing device includes at least one ear extended from the panel and having an orifice formed in the ear to rotatably receive the axle. The securing device includes a pad attached to the panel for selectively and softly or resiliently engaging with the stop the clapper device and for cushioning the clapper device and for preventing the clapper device from striking onto the bell member and the securing device.

The securing device includes a cavity formed in the panel, and the pad includes a stud for engaging into the cavity of the panel of the securing device and for securing the pad to the panel of the securing device. The cavity of the panel and the stud of the pad preferably include a cylindrical structure for solidly securing to each other.

The bell member includes at least one notch formed therein and communicating with the aperture of the bell member, and the securing device includes at least one peg extended therefrom for engaging with the notch of the bell member and for preventing the bell member and the securing device from being rotated relative to each other.

The securing device includes at least one groove for forming at least one rib and for frictionally engaging with the bell member and the handle. The handle includes a bore formed therein for receiving the shank.

The handle includes an engaging surface formed therein for being depressed or engaged by the users, and the securing device includes an engaging surface for engaging with the engaging surface of the handle and for preventing the securing device from rotating relative to the handle.

A spring member may further be provided and engaged between the securing device and the clapper device for biasing the stop of the clapper device to engage with the securing device and for disengaging a clapper member of the clapper device from the bell member.

A positioning device may further be provided for positioning the bell on a supporting surface. The positioning device includes two spring arms having a space formed between the spring arms for receiving and engaging with the handle and for stably grasping the handle between the spring arms.

The positioning device includes a projection extended upwardly from the positioning device for such as the directioning purposes. The spring arms each may include a flat surface for stably engaging with the supporting surface or the table and for preventing the bell from rotating relative to the supporting surface or the supporting table.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a bell in accordance with the present invention;

FIG. 2 is an exploded view of the bell as seen from the upper portion of the bell;

FIG. 3 is another exploded view of the bell as seen from the bottom portion of the bell;

FIG. 4 is a cross sectional view of the bell taken along lines 4-4 of FIG. 1;

FIG. 5 is a cross sectional view similar to FIG. 4, illustrating the operation of the bell;

FIG. 6 is a cross sectional view of the bell taken along lines 6-6 of FIG. 4;

FIG. 7 is a further exploded view illustrating the other arrangement of the bell;

FIGS. 8, 9 are cross sectional views illustrating the operation of the bell as shown in FIG. 7;

FIG. 10 is a still further exploded view illustrating the further arrangement of the bell;

FIGS. 11, 12 are cross sectional views illustrating the operation of the bell as shown in FIG. 10;

FIG. 13 is a side plan schematic view illustrating the positioning of the bell on a supporting surface;

FIG. 14 is a still further exploded view illustrating the positioning device for positioning the bell on the supporting surface; and

FIG. 15 is a perspective view illustrating the positioning device for positioning the bell on the supporting surface.

### DETAILED DESCRIPTION OF THE PREFERRED EMBODIMENT

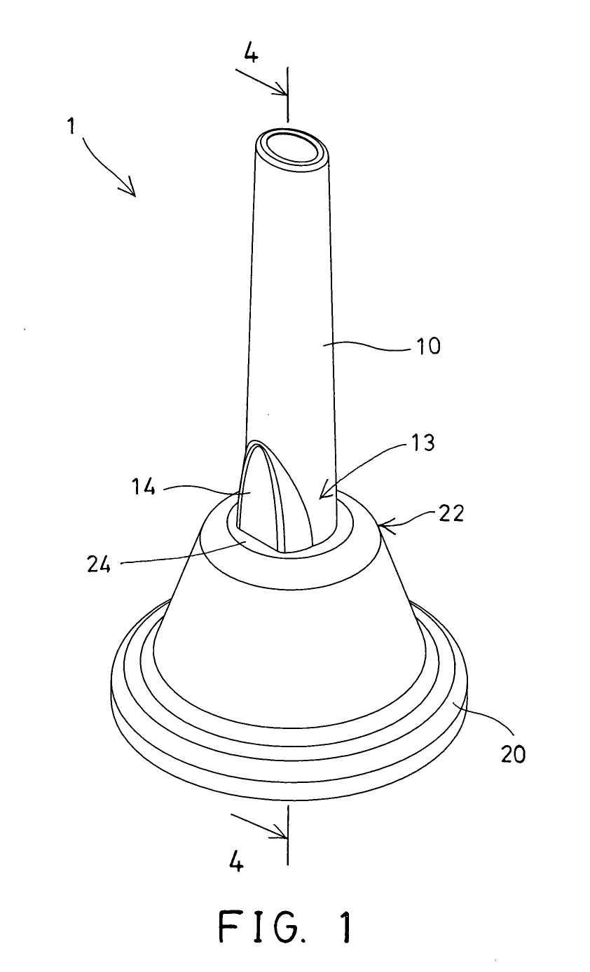

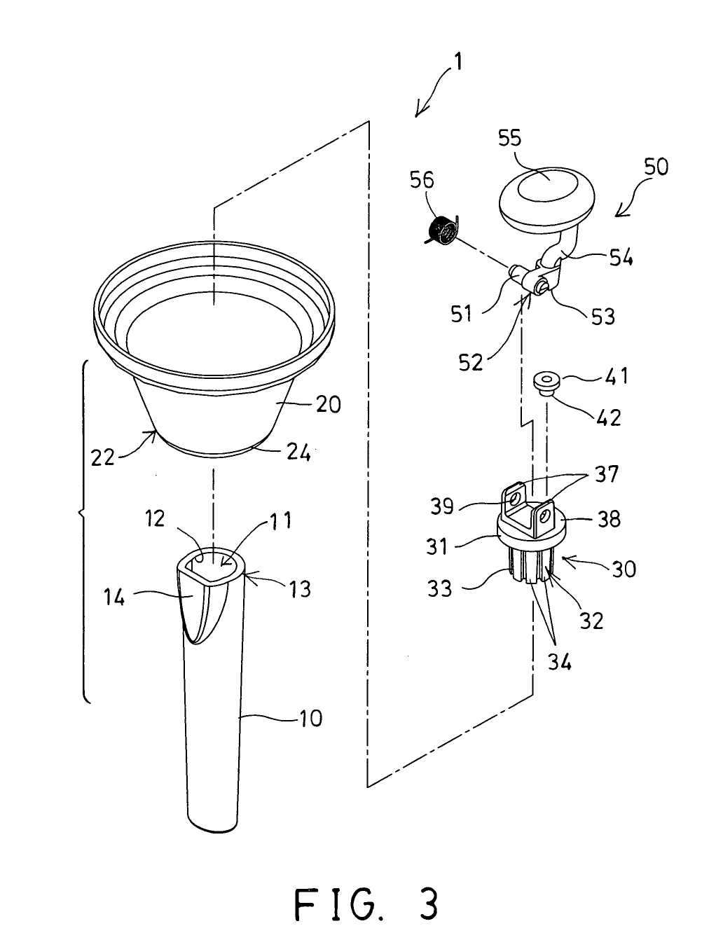

Referring to the drawings, and initially to FIGS. 1-4, a bell 1 in accordance with the present invention comprises a handle 10 including a bore 11 formed therein, and including a non-circular opening 12, such as a D-shaped opening 12 formed or provided in the one end portion 13 thereof, and including a depression or flat or engaging surface 14 formed or provided in the one end portion 13 thereof for being contacted or depressed or held by the users and for directioning the handle 10 and the bell 1.

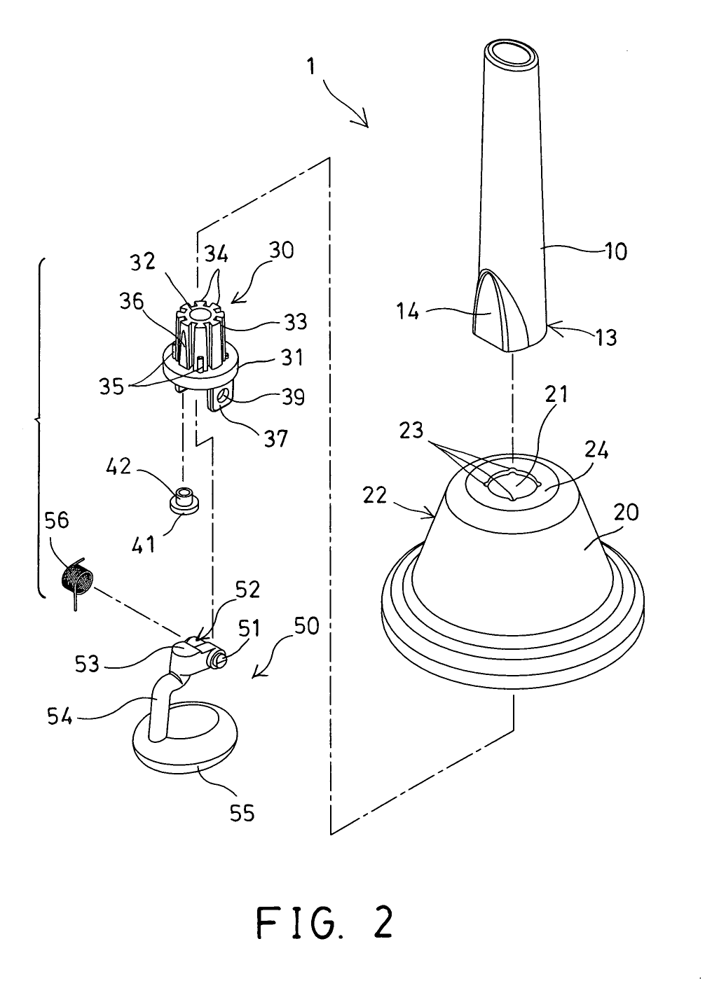

A bell body or bell member 20 includes a frusto-conical form or shape having an aperture 21, such as a non-circular aperture 21 formed in one end portion 22 thereof (FIG. 2) for aligning with the non-circular opening 12 of the handle 10, and includes one or more notches 23 also formed in the one end portion 22 thereof, such as arranged or located around the aperture 21 and communicating with the aperture 21 of the bell member 20.

A coupler or securing device 30 is provided to attach or secure or couple the bell member 20 to the handle 10, and includes a panel 31 for engaging with the inner portion or the base plate 24 of the bell member 20, and the panel 31 includes an outer diameter greater than the inner diameter of the aperture 21 of the bell member 20 for solidly engaging with the base plate 24 of the bell member 20 and for anchoring or retaining or securing the bell member 20 to the handle 10.

The securing device 30 further includes a shank 32 extended from one side of the panel 31 and engageable through the aperture 21 of the bell member 20 and engageable into the bore 11 of the handle 10, and includes one or more grooves 33 formed in the peripheral portion thereof for forming one or more ribs 34 and for frictionally engaging with the bell member 20 and the handle 10, and for solidly securing the bell member 20 to the handle 10 with such as the force-fitted engagement.

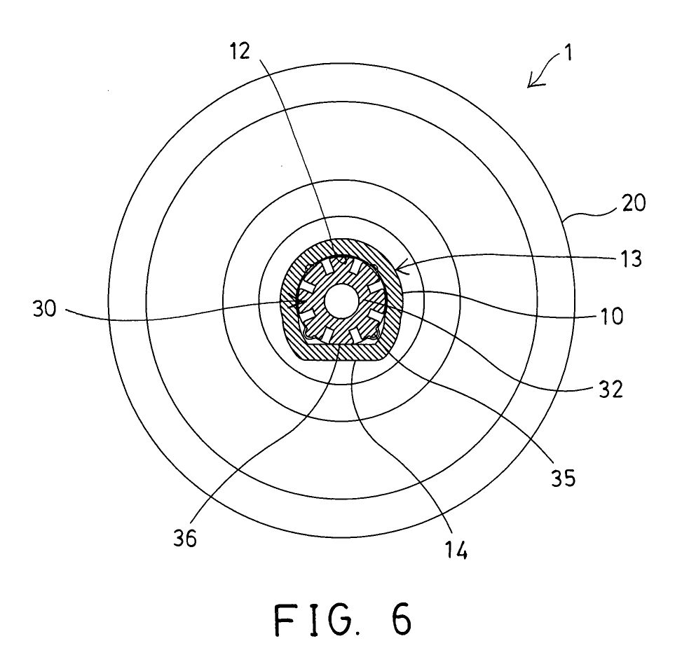

The securing device 30 further includes one or more pegs 35 extended from the panel 31 and/or the shank 32 for engaging with the notches 23 of the bell member 20 and for further stably anchoring the bell member 20 to the securing device 30 and for preventing the bell member 20 and the securing device 30 from being rotated relative to each other, and includes one or more engaging surfaces 36 formed therein (FIGS. 2, 6) for engaging with the engaging surface 14 of the handle 10 and for further stably securing the handle 10 and the bell member 20 and the securing device 30 together in the predetermined or selected angular direction and for preventing the securing device 30 from rotating relative to the handle 10.

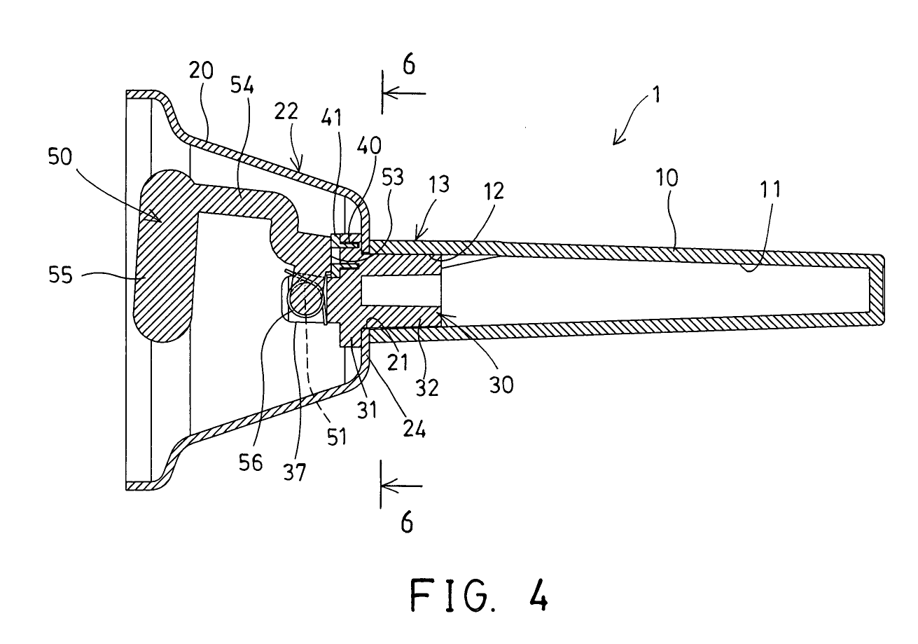

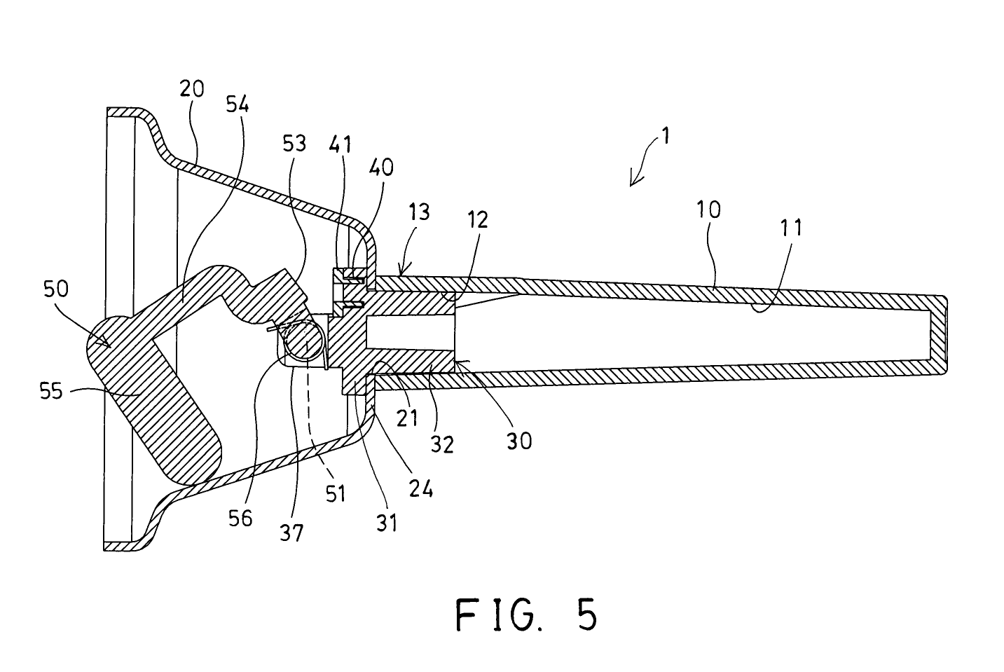

The securing device 30 further includes one or more (such as two) ears 37 extended from the other side 38 of the panel 31 and extended opposite to the shank 32, and the ears 37 each include an orifice 39 formed therein, and further includes a cavity 40 formed therein, such as formed in the other side 38 of the panel 31 (FIGS. 4, 5) and located between the ears 37 and offset from the ears 37, and an anvil or pad 41 is made of soft or resilient materials and includes a cylindrical stud 42 for engaging into the cavity 40 of the panel 31 of the securing device 30 and for stably or solidly securing to the panel 31 of the securing device 30 with such as the force-fitted engagement.

A clapper device 50 includes an axle 51 formed or provided on one end portion 52 thereof and rotatably engaged in the orifices 39 of the ears 37 for allowing the clapper device 50 to be rotated relative to the panel 31 or the securing device 30, and includes a stop 53 also formed or provided on the one end portion 52 thereof for engaging with the pad 41 or the panel 31 of the securing device 30 which may limit the rotational movement of the clapper device 50 relative to the bell member 20 and the securing device 30, and may cushion the clapper device 50 for preventing the clapper device 50 from striking onto the bell member 20 and the securing device 30.

The clapper device 50 further includes a stem 54 extended from the one end portion 52 thereof, and a jinglet, sounder, hammer, tongue, striker or clapper member 55 is coupled or secured to the other end or the free end portion of the stem 54 for hammering or striking onto the bell member 20. A spring member 56 may be engaged onto the clapper device 50, such as engaged onto the axle 51 and engaged with or between the securing device 30 and the clapper device 50 for biasing the stop 53 of the clapper device 50 to engage with the pad 41 of the securing device 30 (FIG. 4), or for disengaging the clapper member 55 from the bell member 20.

In operation, as shown in FIG. 5, when the user hold or grasp the handle 10 and vibrate or oscillate or shake or move the handle 10 and the bell member 20 of the bell 1, the clapper member 55 may be forced to hammer or strike onto the bell member 20 in one direction so as to make a sound. As shown in FIG. 4, when the clapper device 50 is bounced back or biased back to the original position by the spring member 56, the stop 53 of the clapper device 50 may be forced to engage with the pad 41 or to directly engage with the panel 31 of the securing device 30 and thus to prevent the clapper member 55 from hammering or striking onto the bell member 20 in the opposite direction and for preventing the one-way clapper member 55 from striking the bell member 20 in the other or the opposite direction and thus for allowing the sound generated by the one-way clapper member 55 and the bell member 20 to be clearly heard by the users.

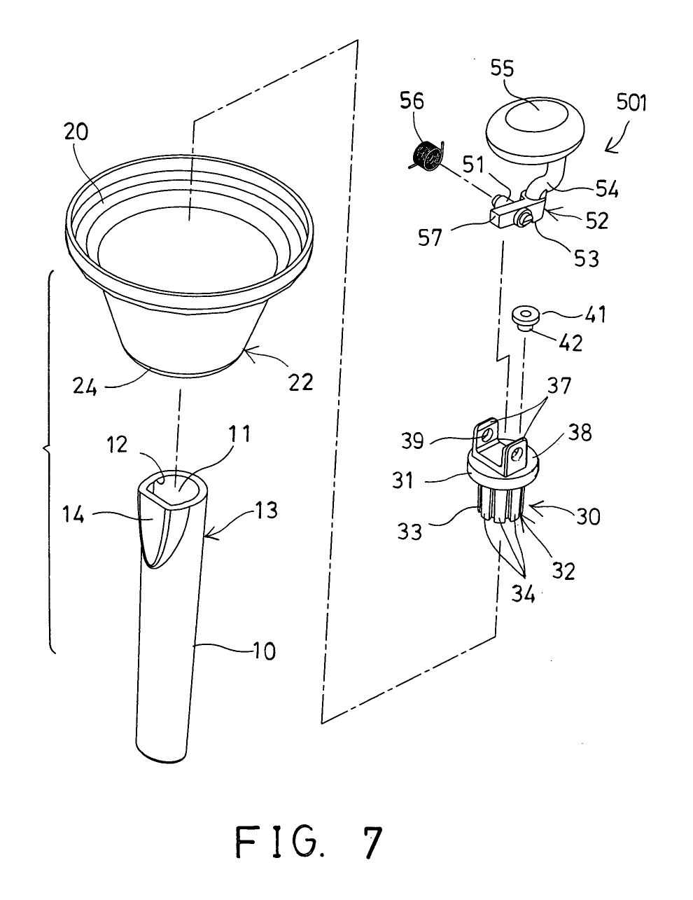

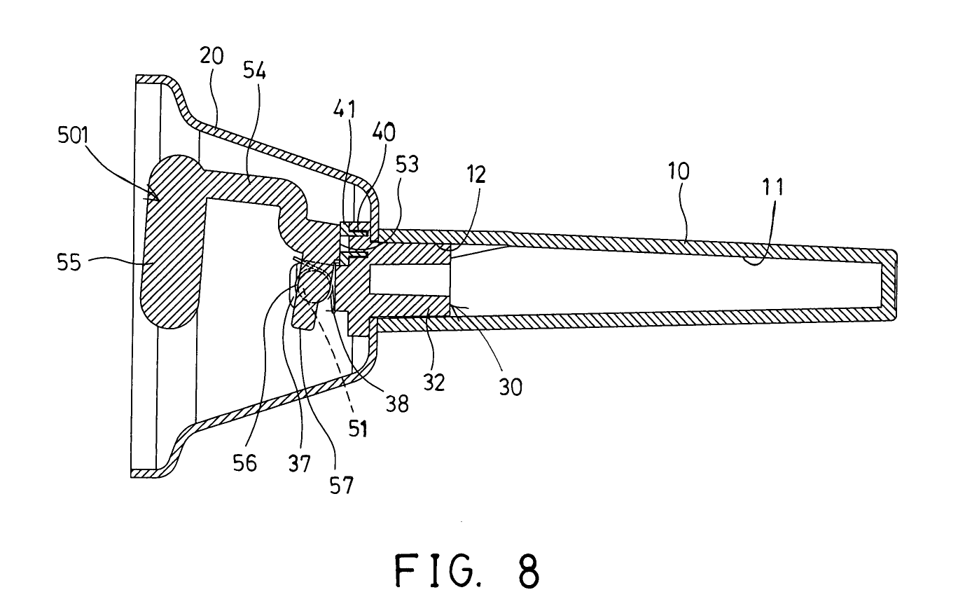

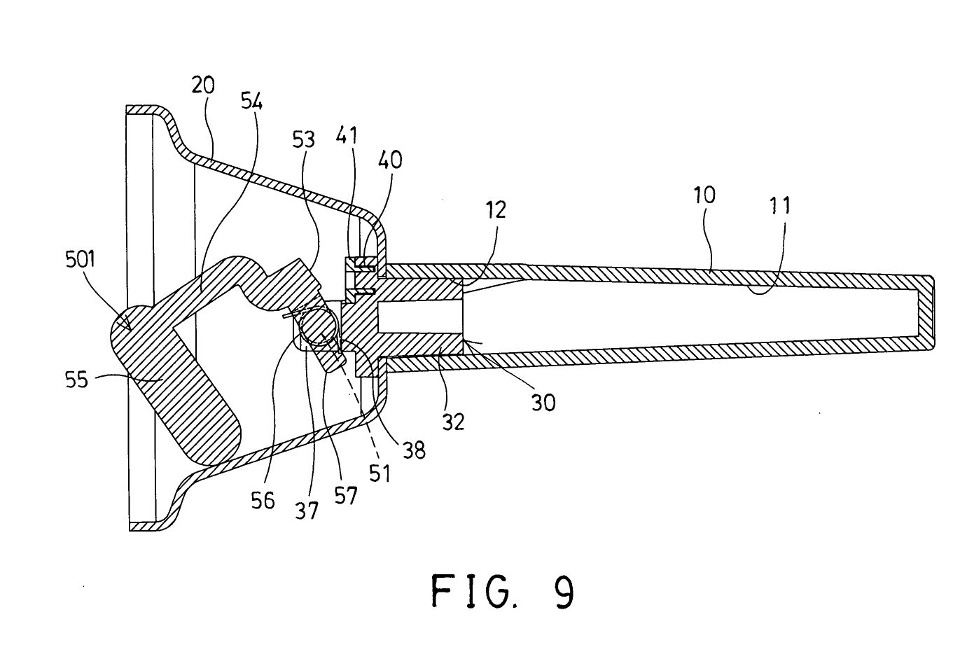

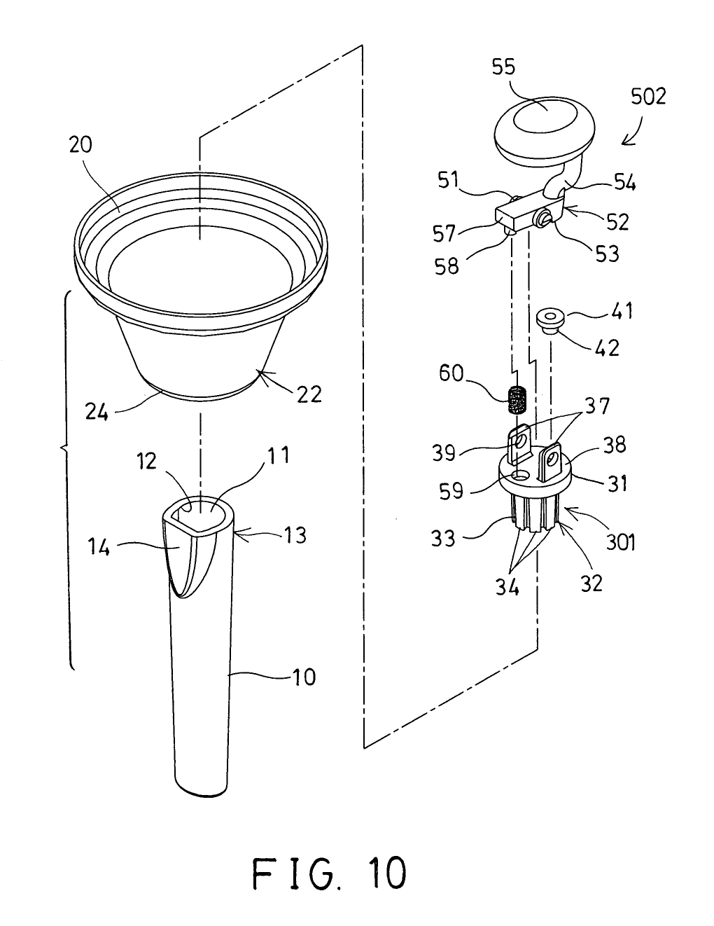

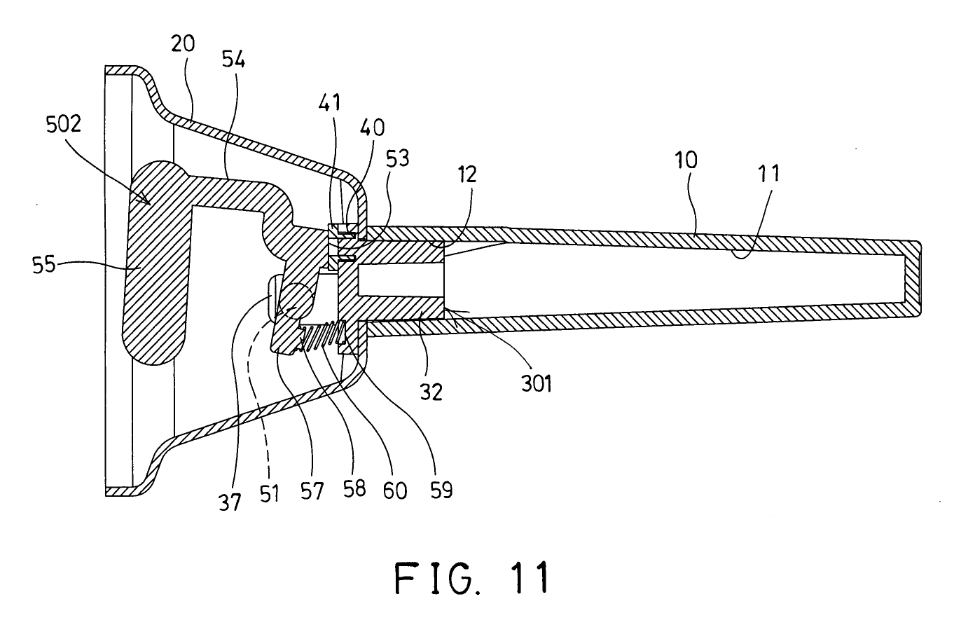

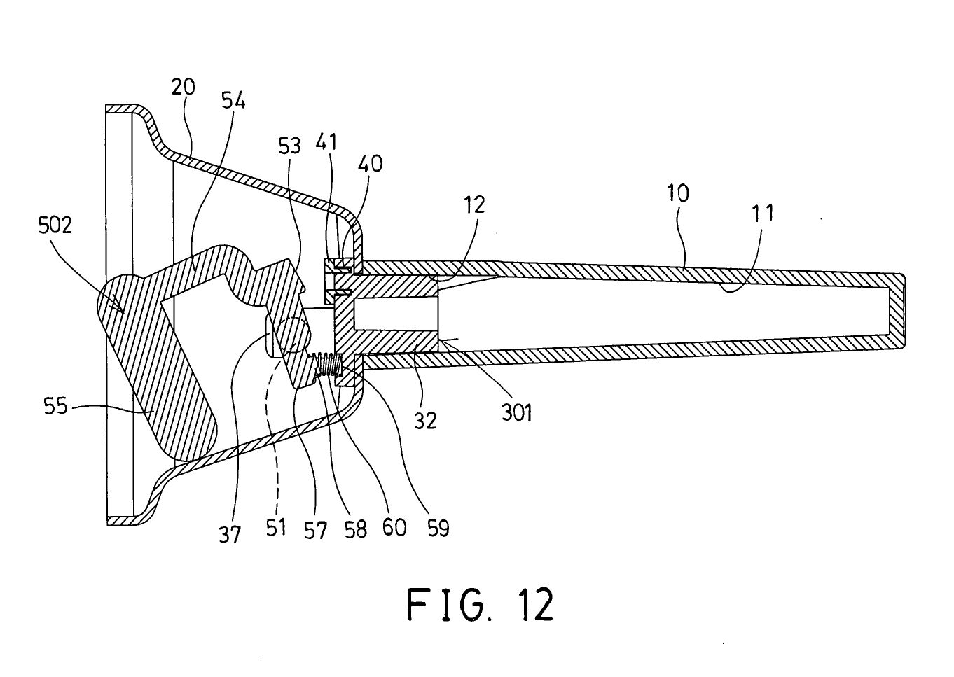

As shown in FIGS. 7-9, the clapper device 501 may include an extension 57 extended therefrom for selectively engaging with the other side 38 of the panel 31 of the securing device 30 (FIG. 9) and for limiting the clapper member 55 to hammer or strike onto the bell member 20 and for preventing the clapper member 55 from over hammering or striking onto the bell member 20. As shown in FIGS. 10-12, the clapper device 502 may include a pin 58 extended from the extension 57, and the securing device 30 may include a recess 59 formed in the other side 38 of the panel 31, and a spring member 60 may be engaged with the recess 59 of the panel 31 and the extension 57 of the clapper device 501 for disengaging the clapper member 55 from the bell member 20.

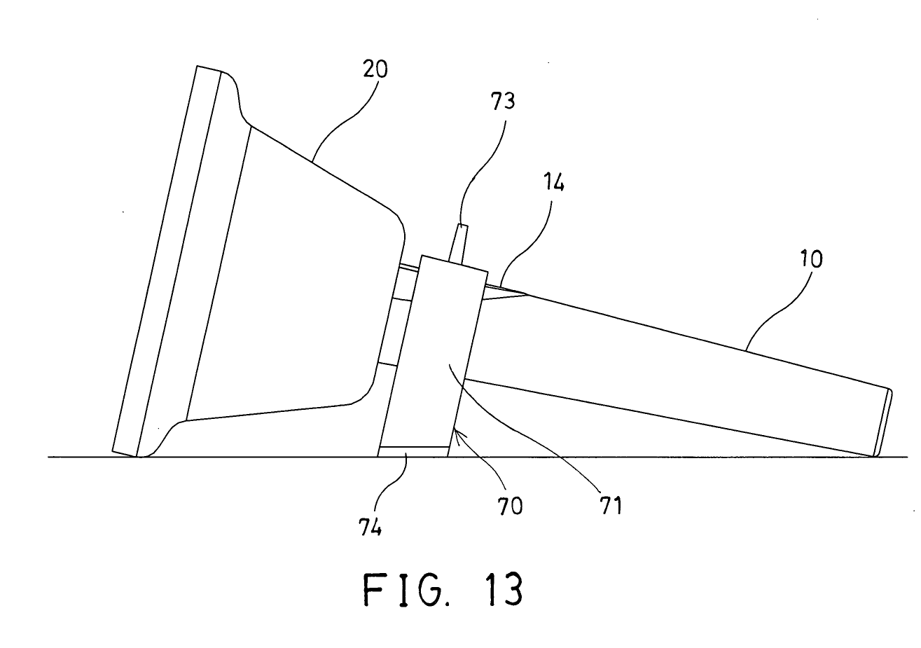

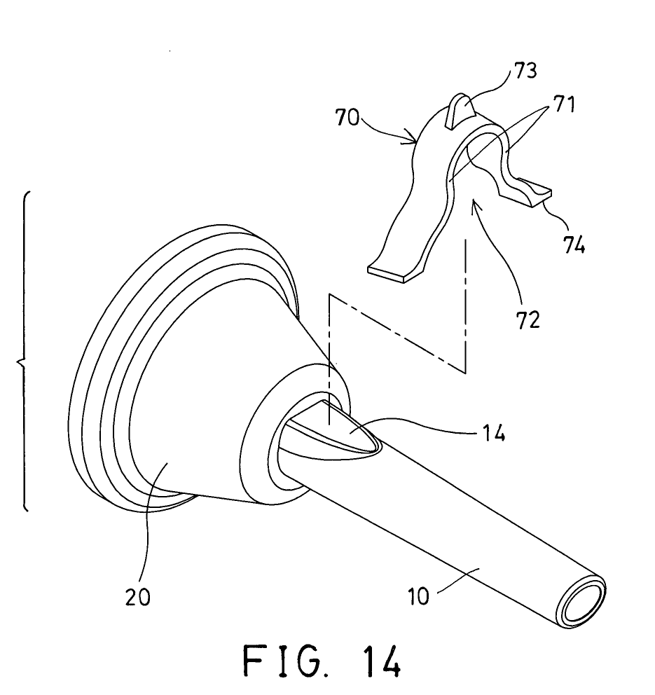

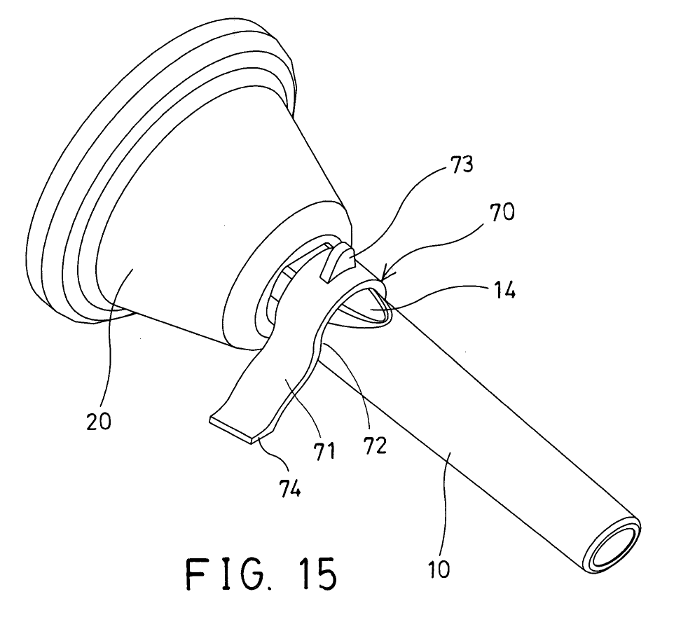

As shown in FIGS. 13-15, a positioning device 70 is provided for positioning the bell 1 on the supporting surface or the like, and includes two spring arms 71 having a space 72 formed or defined between the spring arms 71 for receiving or engaging with the handle 10, and includes a projection 73 extended upwardly from the positioning device 70 for directioning purposes, and the spring arms 71 each include a flat surface 74 for stably engaging with the supporting surface and for preventing the bell 1 from rotating relative to the supporting surface.

Accordingly, the bell in accordance with the present invention includes a one-way clapper for striking the bell member in only one direction and for preventing the one-way clapper from striking the bell member in the other or the opposite direction and thus for allowing the sound generated by the one-way clapper and the bell member may be clearly heard by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A bell comprising:
a handle,
a bell member,
a securing device securing said bell member and said handle together, and
a clapper device including an axle provided on a first end portion and rotatably attached to said securing device for allowing said clapper device to be rotated relative to said securing device and to selectively strike onto said bell member in one direction, and including a stop provided on said first end portion of said clapper device for engaging with said securing device and for limiting a rotational movement of said clapper device relative to said bell member and said securing device, and for preventing said clapper device from striking onto said bell member in an opposite direction.

2. The bell as claimed in claim 1, wherein said bell member includes an aperture formed therein, said securing device includes a panel and a shank extended from said panel and engaged through said aperture of said bell member to secure said securing device to said bell member.

3. The bell as claimed in claim 2, wherein said securing device includes at least one ear extended from said panel and having an orifice formed in said at least one ear to receive said axle.

4. The bell as claimed in claim 2, wherein said securing device includes a pad attached to said panel for selectively engaging with said stop said clapper device and for cushioning said clapper device.

5. The bell as claimed in claim 4, wherein said securing device includes a cavity formed in said panel, and said pad includes a stud for engaging into said cavity of said panel of said securing device and for securing said pad to said panel of said securing device.

6. The bell as claimed in claim 5, wherein said cavity of said panel and said stud of said pad includes a cylindrical structure.

7. The bell as claimed in claim 2, wherein said bell member includes at least one notch formed therein and communicating with said aperture of said bell member, and said securing device includes at least one peg extended therefrom for engaging with said at least one notch of said bell member and for preventing said bell member and said securing device from being rotated relative to each other.

8. The bell as claimed in claim 2, wherein said securing device includes at least one groove for forming at least one rib and for frictionally engaging with said bell member and said handle.

9. The bell as claimed in claim 2, wherein said handle includes a bore formed therein for receiving said shank.

10. The bell as claimed in claim 9, wherein said handle includes an engaging surface formed therein, and said securing device includes an engaging surface for engaging with said engaging surface of said handle and for preventing said securing device from rotating relative to said handle.

11. The bell as claimed in claim 1 further comprising a spring member engaged between said securing device and said clapper device for biasing said stop of said clapper device to engage with said securing device and for disengaging a clapper member of said clapper device from said bell member.

12. The bell as claimed in claim 1 further comprising a positioning device for positioning said bell on a supporting surface.

13. The bell as claimed in claim 12, wherein said positioning device includes two spring arms having a space formed between said spring arms for receiving and engaging with said handle.

14. The bell as claimed in claim 12, wherein said positioning device includes a projection extended upwardly from said positioning device.

15. The bell as claimed in claim 12, wherein said spring arms each include a flat surface for engaging with the supporting surface.
